(19) United States
(12) Patent Application Publication
(10) Pub. No.: US 2010/0137532 A1
(43) Pub. Date: Jun. 3, 2010

(54) CATALYST TO POLYMERIZE OLEFINS AND CONJUGATED DIENES IN HETEROGENEOUS PHASE, PROCESS FOR OBTAINING AND USING THE SAME

(76) Inventors: Odilia Perez-Camacho, Coahuila (MX); Rogelio Alicavan Charles-Galindo, Coahuila (MX); Rebeca Gonzalez-Hernandez, Coahuila (MX); Sergei Kniajanski, New York, NY (US)

Correspondence Address: BROWDY AND NEIMARK, P.L.L.C.;624 NINTH STREET, NW, SUITE 300, WASHINGTON, DC, 20001-5303, US

(21) Appl. No.: 12/446,429

(22) PCT Filed: Oct. 19, 2006
(86) PCT No.: PCT/IB06/02932

§ 371 Date: Jan. 19, 2010

(51) Int. Cl. C08F 4/16; B01J 31/12

(52) U.S. Cl. 526/130; 502/154

(57) ABSTRACT

The invention relates to a catalyst for the heterogeneous phase polymerisation of conjugated dienes and olefins, comprising a pre-catalyst consisting of a mixture of metallocene hydride-aluminohydride compounds: (CpRₓ)T_{y}(CpR′_{z})MHAIH₄ (I), [(CpRₓ)T_{y}(CpR′_{z})MHAIH₄]₂ (II), and [(CpRₓ)T_{y}(CpR′_{z}MH]₂AIH₅ (III), in which M is a transition metal from group IV in the +4 oxidation state thereof; Cp is a cyclopentadienyl ring which may or may not be substituted with R or R′ or a cyclopentadienyl ring in which two adjacent substituents are joined and form cycles in order to form saturated or unsaturated polycyclic cyclopentadienyl ligands; R or R′ are substituents on the cyclopentadienyl rings and may be identical or different; “x” and “z” are integers between 0 and 5; T is a branched or linear acyclic or cyclic covalent bridging group which joins the (Cp) rings; and “y” is 0 or 1. The pre-catalyst is supported on a modified silica and is activated with a co-catalyst. The invention also relates to the method for obtaining the catalyst and to the use thereof in polymerisation reactions.

### TECHNICAL FIELD

The present invention is related to the techniques employed in catalysis to obtain catalysts useful in the olefins and conjugated dienes polymerization and, more particularly, it is related to metallocenes based catalysts to polymerize such type of monomers in an heterogeneous phase, and it is related to the process to obtain and use said catalyst in polymerization reactions.

### BACKGROUND OF THE INVENTION

Most polymerization processes involving metallocenes, mainly suspension or “slurry” or gas phase processes, use immobilized or supported catalysts. Generally, these catalytic systems include a metallocene and alumoxane immobilized in the same support and, subsequently, are dried to form a powder. The use of supported catalysts in polymerization processes prevents “fines” (low mass density particles) to be formed; the supported catalysts dirt less the polymerization reactor walls, which significantly enhance the operation thereof, and provides more useful polymeric products, i.e., higher mass density products.

More particularly, conventional metallocenes based catalysts consist of a monometallic pre-catalyst, which is a metallocene derivative (chloride, hydride, amidryde, alkyl, aryl or alkoxide), supported in an inorganic material such as silica. Examples of these catalysts can be found in U.S. Pat. Nos. 7,041,759 B2; 6,468,936 B1, 5,470,881 and 5,528,475; which are incorporated herein by reference.

Metallocene hydride-alumohydride based complex heterometallics, are a new variant of metallocenes based catalysts, or single-site catalysts, useful in solution or homogeneous phase polymerization and copolymerization of different α-olefins and conjugated dienes. These kind of catalysts in homogeneous phase are described in Mexican Patent Application No. PA/a/1999/07707, which is incorporated herein by reference.

However, It has been observed that said heterometallic compounds are very sensitive to environment humidity and oxygen, thereby being altered to non-catalytic activity systems. Further, very low mass density polymers non-commercially useful are generated, wherein, as mentioned above, supported catalysts are mainly used. Because of this, it can be noted the existing of a technical need to provide supported catalysts which are more stable and which lead to high commercial value polymeric products.

### BRIEF DESCRIPTION OF THE INVENTION

In order to overcome the problems of the prior art related to metallocene hydride-alumohydride compounds catalysts, which generate low catalytic activity and low mass density polymers in the homogeneous phase, a catalyst and a method for the heterogeneousness or immobilization of this type of metallocenes for heterogeneous phase olefins and conjugated dienes polymerization, have been developed. The catalyst of the present invention comprises a pre-catalyst consisting of a mixture of metallocene hydride-alumohydride compounds represented by the following formulas:

(CpRₓ)T_{y}(CpR′_{z})MHAlH₄ (I)

[(CpRₓ)T_{y}(CpR′_{z})MHAlH₄]₂ (II)

[(CpRₓ)T_{y}(CpR′_{z})MH]₂AlH₅ (III)

In formulas (I) to (III), M is a transition metal selected from the group consisting of Ti, Zr and Hf in its oxidation state of +4.

Cp is either i) a cyclopentadienyl ring, unsubstituted or substituted with R or R′; or ii) a cyclopentadienyl ring wherein two neighboring substituents are attached forming cycles having from 4 to 20 carbon atoms such that saturated or unsaturated polycyclic cyclopentadienyl links are formed;

R and R′ are cyclopentadientyl rings substituents which are selected from the group consisting of hydrocarbon radicals wherein one or more hydrogen or carbon atoms are replaced by heteroatoms containing radicals selected from the 13 to 17 groups of the periodic table, and heteroatoms substituted with hydrogen or substituted with hydrocarbon radicals; R and R′ are the same or different;

“x” and “z” are integers ranging from 0 to 5, and denoting the substitution level for the cyclopentadienyl rings.

T is a linear or branched, cyclic or acyclic, bridged covalent group bonding the cyclopentadienyl rings (Cp);

Finally, “y” is an integer which may be 0 or 1.

The pre-catalyst is supported in a modified silica, in a preferred embodiment of the invention, said silica is modified by heat treatment and an activating component selected from a compound of trialkylaluminium (AlR3), methylaluminoxane (MAO) or modified methylaluminoxane (MMAO). The modified silica is a fundamental issue for the outstanding behavior of the catalyst of the present invention with respect to the same but unsupported catalyst. While developing the present invention, it was found that not all inorganic supports are capable for the pre-catalyst to be immobilized therein, since they can be altered to systems not showing catalytic activity at all.

The catalyst of the present invention also comprises a co-catalyst (activator) selected from the group consisting of MAO, MMAO and a boride compound of the general formula B(C₆H_{5-K}Fₖ)₃ or PB(C₆H_{5-K}Fₖ)₄; wherein k is an integer ranging from 0 to 5; and, P is a cation capable of taking off an hydride atom forming a neutral species not showing a Lewis' basic functionality.

In one aspect of the invention, a process to obtain the above defined immobilized catalyst is provided, and which is used for heterogeneous phase olefins and conjugates dienes polymerization. The obtainment process for the catalyst comprises the steps of preparing a pre-catalyst solution, which, as previously mentioned, consists of a mixture of metallocene hydride-alumohydryde compounds of the formulas (I), (II) and (III).

Moreover, in the obtainment process, a silica is heat treated, being the pre-catalyst support. In a preferred embodiment of the process, the heat treatment is performed at a temperature ranging from about 400° C. to about 800° C. in the presence of an oxygen O₂ stream. Then, the heat treated silica is modified with an activator selected from trialkylaluminium (AlR3), MAO or MMAO.

Once the modified silica has been prepared, it reacts with the pre-catalyst solution, such that when the reaction is completed, the silica remains impregnated with the pre-catalyst.

Further, the silica impregnated with the pre-catalyst is dried; and, the pre-catalyst is activated with a co-catalyst selected from the group consisting of methylaluminoxane (MAO), modified methylaluminoxane (MMAO) or a boride compound of the general formula B(C₆H_{5-K}Fₖ)₃ or PB(C₆H_{5-K}Fₖ)₄ as defined above.

Finally, in yet another aspect of the present invention, a process for the heterogeneous phase olefins and conjugated dienes polymerization is provided, using the above defined catalyst. The polymerization process essentially comprises reacting, under polymerization conditions, at least one olefin and/or at least one conjugated diene contacting the catalyst; and, recovering the polymer thus formed. In a preferred embodiment, the olefins and conjugated dienes polymerization is performed in a gas phase, and in another embodiment, in suspension. When the polymerization is performed in suspension, the polymerization reactor is charged with a suitable solvent and taken up to the polymerization pressure, then, the catalyst of the present invention is added. In another embodiment of the suspension polymerization, the catalyst is activated within the reactor. On the other hand, in the gas phase polymerization, the reactor is initially charged with the catalyst of the present invention and then the reactor is taken up to the polymerization conditions.

As can be seen, an object of the present invention is to provide a metallocene hydride-aluminohydride compound catalyst for the heterogeneous phase olefins and conjugated dienes polymerization, with the catalyst having more stability, more easy of handling and more catalytic activity with respect to the same catalyst used in an homogeneous phase, i.e., without support.

### BRIEF DESCRIPTION OF THE DRAWINGS

The novel aspects considered characteristics of the present invention will be particularly set forth in the appended claims. However, the catalyst of the present invention, together with other objects and advantages thereof, will be better understood from the following detailed description, when read together with the accompanying drawings, in which:

FIG. 1 is a flow chart illustrating the obtainment process for the catalyst of the present invention.

### DETAILED DESCRIPTION OF THE INVENTION

The catalyst for the heterogeneous phase olefins and conjugated dienes polymerization comprises: a pre-catalyst consisting of a mixture of metallocene hydride-alumohydride compounds represented by the following condensed formulas:

(CpRₓ)T_{y}(CpR′_{z})MHAlH₄ (I)

[(CpRₓ)T_{y}(CpR′_{z})MHAlH₄]₂ (II)

[(CpRₓ)T_{y}(CpR′_{z})MH]₂AlH₅ (III)

That is, the pre-catalyst integrated by the compounds of the formulas (I) to (III) is based in transition metals bis(cyclopentadienyl)hydride-alumohydride complexes, said transition metals belonging to group 4 of the periodic table of the elements. For a better understanding, the compounds of formulas (I), (II), and (III) may be represented by the following structures:

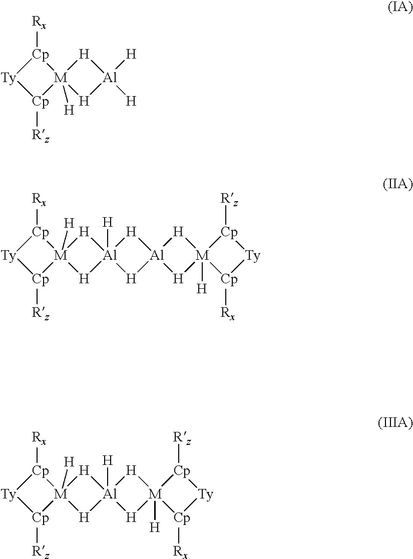

Referring again to the formulas (I) to (III), as mentioned above, M is a transition metal selected from the group consisting of Ti, Zr and Hf, in its oxidation state of +4. Preferably, the transition metal is zirconium.

Cp is either i) a cyclopentadienyl ring, unsubstituted or substituted with R or R′; or ii) a cyclopentadienyl ring wherein two neighboring substituents are attached forming cycles having from 4 to 20 carbon atoms such that saturated or unsaturated polycyclic cyclopentadienyl links are formed.

R and R′ are cyclopentadientyl ring substituents which are selected from the group consisting of hydrocarbon radicals wherein one or more hydrogen or carbon atoms are replaced with heteroatom containing radicals, selected from the 13 to 17 groups of the periodic table, and hydrogen substituted or hydrocarbon radicals substituted heteroatoms; R and R′ are the same or different. Preferably, R and R′ are hydrocarbon radicals wherein one or more atoms thereof are replaced with radicals having heteroatoms belonging to the 14 group of the periodic table.

“x” and “z” are integers ranging from 0 to 5, and denoting the substitution level of the cyclopentadienyl rings (Cp).

T is a linear or branched, cyclic or acyclic, bridged covalent group bonding the cyclopentadienyl rings (Cp).

Finally, “y” is an integer which may be 0 or 1. Preferably, when “y” is 1, T is selected from the group consisting of hydrocarbon radicals wherein one or more hydrogen or carbon atoms are replaced by heteroatoms containing radicals selected from the 13 to 17 groups of the periodic table, and hydrogen or hydrocarbon radicals substituted heteroatoms. Particularly, the T heteroatoms are selected preferably from the 14 group of the periodic table.

In Table 1, preferred metals for M, groups for T and either substituted or unsubstituted cyclopentadienyl rings for the formulas (I) to (III) are listed.

TABLE 1

| M | T_{y} (y = 0, 1) | (CpRₓ) y/o (CpR′_{z}) |
|---|---|---|
| Titanium | Methylidene | Cyclopentadienyl |
| Zirconium | Iso-propylidene | Methylciclopentadienyl |
| Hafnium | Diphenylmethylidene | Dimethylciclopentadienyl |
| | Ethylidene | Tetramethylciclopentadienyl |
| | Cyclohexylidene | Pentamethylcyclopentadienyl |
| | 4-piperidinylidene | tert-butylcyclopentadienyl |
| | 4- | 1-tert-butyl-3- |
| | tetrahydropiranylidene | methylciclopentadienyl |
| | Dimethylsilylidene | Trimethylsilylcyclopentadienyl |
| | Diethylsilylidene | 1-trimethylsilyl-3- |
| | | methylcyclopentadienyl |
| | Diphenylsilylidene | di-tert-butylciclopentadienyl |
| | Tetramethyldisilylidene | Dimethylborylcyclopentadienyl |
| | Tetramethyldisiloxane | Indenyl |
| | Borylidene | Tetrahydroindenyl |
| | Methylborylidene | Fluorenyl |
| | Phenylborylidene | Octahydrofluorenyl |
| | Methylimine | tert-butylindenyl |
| | Ethylamine | Trimethylsilylindenyl |
| | n-butylimine | tert-butyltetrahidroindenyl |
| | Oxo | Trimethylsilyltetrahydroindenyl |
| | Sulphur | 2,7- |
| | | dimesityloctahydrofluorenyl |

Turning now to the pre-catalyst, such as mentioned above, it consists of a mixture of the compounds of formula (I), (II), and (III) at different ratios, which depend on the solvent said compounds are dissolved in and the solution molar concentration. For example, in organic solvents such as ethyl ether, benzene or toluene, at concentrations lower than 10⁻³ M, the compound of formula (I) predominates. In the range of concentrations higher than 10⁻³ M or in the solid state, the existing compounds have the dimer form, i.e., the compound of formula (II) or of formula (III). The mixture of compounds release aluminium hydride (AlH₃), the hydrides thereof being at dynamic equilibrium with the bridged hydrides and terminals of the heterometallic pre-catalysts such as particularly represented by Scheme 1 for the compound of structure (I) or (IA).

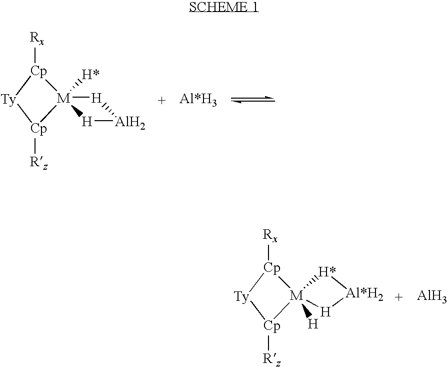

With regard to the above, all possible forms (I), (II), and (III) or isomeric structures of the different aggregates of the heterometallic system are in reversible dynamic interchange of the bridged hydride links and terminals with the aluminium hydride present in the media, as represented by Scheme 1. All pre-catalyst forms represented by formulas (I) to (III) are active in the olefins and conjugated dienes polymerization and copolymerization.

Adding 2.2 equivalents of aluminium and lithium hydride to a corresponding solution of the respective metal metallocene dichloride, according to the formulas I to III, in ethyl ether at 0° C., the pre-catalyst is synthesized; then, the solvent is evaporated. The heterometallic complex is extracted in an aromatic solvent such as benzene or toluene, the lithium chloride formed is filtered, and the resulting solution has the compound of interest. Further, the pre-catalyst solution is contacted with the support material, i.e., the modified silica, in order to immobilize the pre-catalyst.

Regarding the above, it can be noted that in order to immobilize the catalyst, the modified silica has been modified by a heat treatment and an activator component selected from a compound of trialkylaluminium (AlR3), MAO or MMAO. Preferably, the silica is fuming silica, or PQ silica, preferably with a surface area from about 250 to 450 m²/g, preferably 416 m2/g and a pore volume according to the N₂ adsorption of about 2.1 to 4.2 ml/g, preferably 3.23 ml/g, with an average pore diameter of 311 Å. The way by which the silica is modified is described below.

The catalyst remaining component is a co-catalyst selected from the group consisting of methylaluminoxane (MAO), modified methylaluminoxane (MMAO), and a boride compound of general formula B(C₆H_{5-K}Fₖ)₃ or PB(C₆H_{5-K}Fₖ)₄; wherein k is an integer ranging from 0 to 5; and, P is a cation capable of taking off an hydride atom forming a neutral species not showing a Lewis' basic functionality. Preferably, the co-catalyst is B(C₆F₅)₃ or CPh₃B(C₆F₅)₄, in addition, the co-catalyst being MAO or MMAO is preferred. In the catalyst, for example, the molar ratio from MAO to MMAO with respect to the metallocene and aluminium hydride compounds of the formulas (I), (II) and (III) molar total is from about 10:1 to about 20,000:1; and for the specific activation with boride compounds, wherein the transition metal is zirconium, a molar ratio of about 1:3 to 1:10 is used (Zr:B ratio).

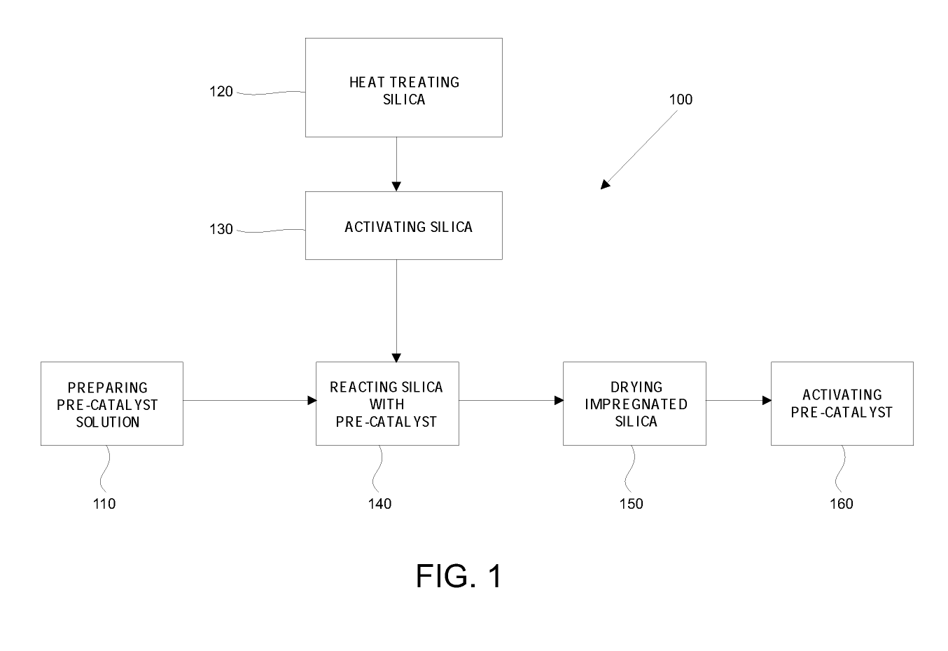

The obtainment process for the catalyst of the present invention will be described in the following, with reference to FIG. 1 showing a block chart for the catalyst obtainment process 100. Starting, in step 110, a pre-catalyst solution is prepared, which, as previously mentioned, consists of a mixture of metallocene hydride-alumohydride compounds of the formulas (I), (II) and (III). The pre-catalyst solution solvent is an organic solvent selected from the group consisting of benzene, toluene, hexane and the isomers thereof, heptanes, methylene chloride, chloroform and trichlorobenzene.

In this sense, it is important to note that although the metallocene hydride-alumohydride compounds of the formulas (I), (II) and (III) are initially synthesized in ethyl ether, this solvent must be removed or substituted before performing the reacting step of the pre-catalyst with the support (step 140, which will be described below), since it has been proved that, in polymerization reactions wherein catalysts with pre-catalyst being dissolved in ethyl ether in step 140 were used, said catalysts showed very low or null activities. Summarizing, ethyl ether is not a good solvent for the pre-catalyst to be initially in the step 110 and further to continue with the process 100 described.

Turning to FIG. 1, a silica is heat treated in step 120, said heat treatment is preferably performed using a temperature from about 400° C. to about 800° C. in the presence of an oxygen O₂ stream, for an approximate period of time from 2 hours to 6 hours, preferably of 6 hours. Then, the silica is cooled under N₂ atmosphere, and treated under an inert atmosphere to prevent the deactivation thereof.

In the next step of the process, being the activation step 130 of the heatly treated silica, an activator selected from the group consisting of trialkylaluminium (AlR3), MAO or MMAO is used; the trialkyl aluminium compound is selected from the group consisting of Et₃Al, Me₃Al or iBu₃Al. In a preferred embodiment, the heat treated silica is contacted by a saturated solution or using different percentages of said activators, while stirring the heterogeneous solution for a period of time of about six hours at room temperature, and then filtering the silica.

In an additional embodiment, the modified silica is washed several times to remove the AlR₃, MAO or MMAO excess and is dried under vacuum to remove the remaining solvent. The representation of the specific MAO modified silica is shown in the formula IV.

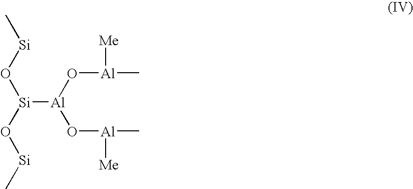

Fuming silica or PQ silica is the silica preferred in the present invention, in step 130 from about 10 to about 45% by weight ratio of activator agent with respect to the silica is used. It is important to note that a key factor for the catalyst outstanding activity is the utilized support. In this regard, as stated in the background of the invention, metallocene hydride-alumohydride compounds are very sensitive and, as the present invention developed, it was found that they cannot be immobilized in a non-thermically treated silica in the presence of oxygen such as set forth in the present invention, because said compounds decompose into systems not showing catalytic activity. Fortunately, in the present invention, it was found that modifying the silica by a heat treating and with an activator, as those mentioned above, compounds of the formulas (I) to (III) are stably immobilized which highly benefit the olefins and conjugated dienes polymerization.

Turning to FIG. 1, once the silica has been modified at the end of step 130, in step 140 it reacts with the pre-catalyst solution from step 110, such that when the reaction is completed, the silica is impregnated with the pre-catalyst. Preferably, in this step of the process, the modified silica is suspended in a solvent selected from the group consisting of toluene, hexane, benzene, methylene chloride and chloroform.

This reaction step 140, is performed under an inert gas atmosphere, such as Ar, while stirring at room temperature, since the hydride-alumohydride is thermally unstable and sensitive to impurities like humidity and oxygen in air.

Moreover, in reaction step 140, a pre-catalyst:silica ratio on the order of 10% by weight is used, or a pre-catalyst/silica (Al:Si) molar ratio from about 1:10 to about 1:100 may be used, preferably 1:40 or 1:70 ratios. Important to mention is that in this step 140, the ratios as used depend on the type of metallocene hydride-alumohydride employed and its catalytic activity, as well as the monomer polymerization conditions in which it will be used. Generally, higher the catalytic activity of a catalyst as the one of the present invention, preferably lower the pre-catalyst:silica ratio, in order to suitable controlling the polymerization reaction being exothermal.

In a further embodiment of the process, following step 140, the method comprises an additional step for washing the impregnated silica by the use of the same solvent where the silica is suspended in.

Once the silica has been impregnated following step 140, a drying step 150 is performed, this step is carried out preferably evaporating under vacuum the reaction mixture such that the inorganic support (silica) precipitates. At the end of the drying step 150, a slightly heavier powder is obtained, with variable color depending on the kind of linkages the pre-catalyst has. Generally, for hydride-alumohydrides, the color of the impregnated silica is from pink to dark pink.

Immobilized or supported pre-catalyst in activated and MAO modified silica is represented by the formula (V), as follows:

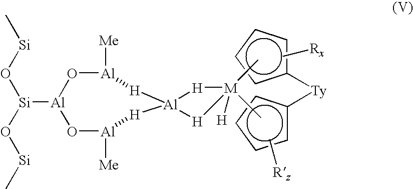

Finally, in step 160, the supported pre-catalyst is activated by a co-catalyst selected from the group consisting of methylaluminoxane (MAO), modified methylaluminoxane (MMAO) or a boride compound of the general formula B(C₆H_{5-K}Fₖ)₃ or PB(C₆H_{5-K}Fₖ)₄, wherein the subscript k and P group are as defined above.

Preferably, methylaluminoxane (MAO) is the used co-catalyst, this compound being the catalyst most widely used in polymerization reactions with metallocenes, due to its capability of activating or ionizating a great number of metallocenes and other transition metals containing complexes. The MAO structure consists of a mixture of oligomers and/or clusters of cyclic and linear aggregates having an approximate composition of (MeAlO)ₙ, wherein n ranges from about 5 to about 20.

Besides being the activator component, MAO is used as a excess hydroxyl group (OH) deactivator agent in the silica support, for the metallocene hydride-alumohydride pre-catalysts of formula (I) to (III) immobilization. In the following Scheme 2, the activation of the supported catalyst in activated and modified silica, in this case with MAO, is represented.

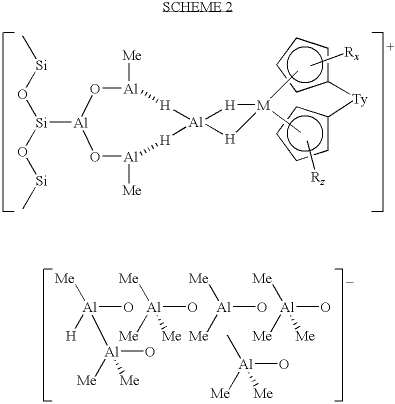

Between 10 and 20000 MAO equivalents per transition metal mol in the impregnated support are preferably added in the activation step 160. The silica powder containing the pre-catalyst already immobilized obtained in step 150 is suspended in hexane or toluene in this step, and the corresponding activator (MAO) or deactivator amount is added at room temperature. A slightly change in the solution's color characterizes the activation reaction, although with a great excess of MAO it may not be possible to notice this color change sometimes.

Besides MAO, other activators can be used, such as B(C₆F₅), or CPh₃B(C₆F₅)₄. Temperature in this step ranges between from −50 to 25° C. The pre-catalyst powder changes in color, from pink to dark orange, which makes evident the formation of the catalytic system. It is to be noticed the very high sensitivity of this kind of activators and catalytic systems obtained from this kind of reactions to air and protic substances (e.g. water, alcohols, acids, etc), requiring the use of the Schienk technique for the handling in Ar-vacuum lines, to warranty an inert atmosphere, as well as the required Ar gas, solvent, and monomers strict purification.

The heterogeneous phase olefins and conjugated dienes polymerization process will be now described, which comprises the steps of: reacting at least one olefin and/or at least one conjugated diene contacting the catalyst, under polymerization conditions; and, recovering the polymer thus formed. Polymerization reactions may be performed in both gaseous phase or in suspension (slurry).

Generally, for suspension polymerizations, a polymerization reactor is charged with a reaction suitable solvent, for example, hexane, toluene, heptanes or iso-octane. Optionally, a purifying or scavenger agent may be added, such as TIBA (tri-isobutylamine in toluene), preferably 3 ml of TIBA per 2 liters of the reaction solvent is used. Then, the reactor is saturated with the corresponding monomer (ethylene, propylene, butadiene, etc.) at the polymerization pressure, for these monomers typical values are in the pressure range of about 0.70 to about 140.61 kg/cm² (10 to 2000 psi), or monomer in the liquid state is added, and finally the catalyst of the present invention is added, which is preferably in suspension. The system is allowed to polymerize for sufficient time depending on the temperature and the recorded monomer consumption.

In an alternative embodiment of the polymerization process, part or all the co-catalyst (MAO, MMAO or boride compounds defined above) is added to the reactor together with the polymerization solvent at the determined temperature, and then, the supported hydride-alumohydride pre-catalyst is added, i.e., the pre-catalyst activation is carried out inside the polymerization reactor. This pre-catalyst activation inside the same reactor represents an increase in the catalytic activity, since the activated catalytic system handling is avoided, which is a highly sensitive ionic pair.

In copolymerization reactions, generally the liquid or gaseous co-monomer is previously added in certain percentage or determined amount to the polymerization reactor, to further continue with the above described polymerization process.

When a chain transfer agent, such as hydrogen, is used to control the molecular weight of formed polymers, this, as the co-monomer, is previously added to the polymerization reactor and the described process is continued. Polymer recovery is achieved by conventional methods like methanol washing or 10% acidified methanol with HCl.

On the other hand, for gaseous phase polymerization, the same steps and conditions are used as in the suspension polymerization, however, in this case the reactor is initially charged with the already activated catalyst of the present invention. Preferably, the polymerization can be carried out in a fluidized bed reactor.

In the heterogeneous polymerization process of the present invention, a minimum concentration of the catalyst is used, of the order of 10⁻⁶ molar. The obtained polymers have a molecular weight up to 1.5×10⁶ and a polydispersity between 2 and 4. It is to be noted that both the activity and the polydispersity for the heterogeneous phase polymers thus obtained tend to decrease and increase, respectively, compared to the same unsupported catalysts, i.e., in homogeneous phase.

In the polymerization process of the present invention, the olefins used have the general formula (VI)

CH₂═CH—CHXY (VI)

Wherein “X” and “Y” are independently an hydrogen atom; a linear, branched or cyclic, saturated or unsaturated hydrocarbon radical; a linear, branched or cyclic, saturated or unsaturated hydrocarbon radical, wherein one or more hydrogen or carbon atoms are replaced by heteroatoms containing radicals selected from the 13 to 17 groups of the periodic table; heteroatoms selected from the 13 to 17 groups of the periodic table substituted with hydrogen or hydrocarbon radicals. Some α-olefins illustrative examples are propylene, 1-butene, 1-hexene, iso-butene, alylbenzene, 3-chloropropylene. The three different kinds of polymers above described, obtained in the monomer polymerization of general formula (IV), are represented in Scheme 3.

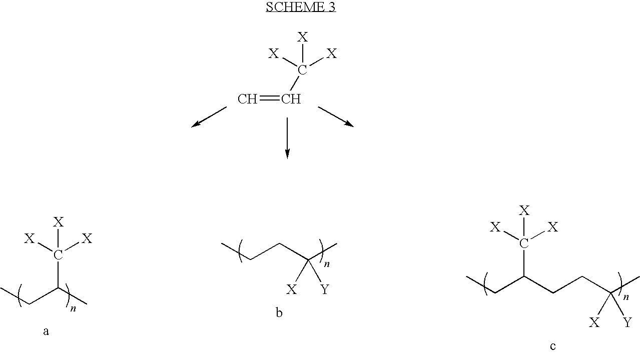

As a function of the temperature and environment generated by the substituents of the cyclopentadienyl links (Cp) in the transition metal (see formulas IA and IIIA), the polymers obtained using the catalysts to which reference is made, may have regular stereo-specific structures generated from monomer 1,2 or 2,1 insertions (Scheme 3a), or polymers resulting from monomer 1,3 insertions (Scheme 3b), or random co-polymers wherein both types of monomer insertions are represented (Scheme 3c).

In the olefins polymerization, main chains of the resulting polymers and co-polymers have a fragment content formed by the 1,3 insertion from about 0.1 to about 95%. Furthermore, the tacticity of the resulting polymers and co-polymers is from about 40% to about 80%. Further, polymers have been obtained with features and properties like those obtained with conventional single-site catalysts, having tacticities in the range from about 40 to about 80% as determined by ¹³C MNR. This property tends to decrease also for the supported catalysts of the present invention compared with the corresponding analog systems thereof in solution (Mexican Patent Application No PA/a/1999/07707).

On the other hand, the conjugated dienes to be polymerized, are selected from the group consisting of butadiene, isoprene, cyclopentadiene unsubstituted or substituted with alkyl, haloalkyl or alkylsilyl groups. Preferably, the conjugated diene is cyclopentadienyl unsubstituted or substituted with alkyl, haloalkyl or alkylsilyl groups. With the substituted or unsubstituted cyclopentadienyl polymerization, polycyclopendadienes are obtained having repetitive fragments of the formula (VII).

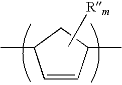

wherein, fragments of formula VII are at least 95% in the resulting polymer, where “m” is an integer ranging from 0 to 3, and R″ is a hydrocarbon radical or trialkylsilyl. Depending on the polymerization temperature and the environment generated by the cyclopentadienyl links in the transition metal, the resulting polymers using the catalyst to which reference is made, in the conjugated dienes polymerization, may have fragments resulting form 1,4-cis insertion in the range from about 40 to about 75%.

Catalyst for heterogeneous phase olefins and conjugated dienes polymerization, process for the obtainment thereof and the polymerization process in which is used, will be clearly illustrated by the way of the examples described in the following, which are to be considered merely illustrative, and non-limitative of the present invention.

### Example 1

### Synthesis of the Zirconocene Hydride-Alumohydride Pre-Catalyst

A zirconocene dichloride Cp₂ZrCl₂ solution in ethyl ether, with a molarity between 0.01-0.2 M, was cooled to 0° C. in an ice water bath. Then, 2.2 equivalents of a LiAlH₄ 0.1 M solution in ethyl ether was added. When the addition was completed, the mixture was left to room temperature, and the ethyl ether was evaporated under vacuum to dryness. The zirconocene hydride-alumohydride complex was extracted from the LiCl by-product in toluene solution by filtration, obtaining a colorless solution. The quantitative reaction yielding was of about 100% based on the initial metallocene Cp₂ZrCl₂ moles.

### Example 2

### Pre-Catalyst Immobilization (Heterogeneousness)

The metallocene hydride-alumohydride pre-catalyst obtained in example 1, was supported in previously deactivated and modified with temperature and MAO fuming silica,

Particularly, the silica used in the pre-catalyst support, was fuming silica having a surface area of 416 m²/g, pore volume according to N₂ adsorption about 3.23 ml/g and average pore diameter of 311 Å.

For the activation, the silica was taken up in a Pyrex glass column 60 cm length, and about 4 cm diameter. The silica packed column was heated to about 600° C., with an inside-through low flow of O₂ stream, for a period of time of about 6 hours. Then, the silica was cooled with a N₂ stream within the same packed column and, further, was handled at an inert atmosphere to avoid the deactivation thereof due to air humidity and oxygen of the air.

Then, 10 g of silica (activated) were taken up in a 100 ml “pear” Schienk and suspended in 40 ml of toluene, previously dried and purified. Further, 10 ml MAO were added (10% toluene solution) and the mixture was stirred for 6 hours at room temperature. After this time, the silica was filtered from the toluene solution under Ar atmosphere and washed several times for the MAO residues extraction and vacuumed to dryness for a period of time of 4 hours. The deposited MAO content was gravimetrically computed, in most cases obtaining a MAO impregnation percentage between 19 and 21% by weight regarding the initial silica weight.

Afterwards, the metallocene hydride-alumo-hydride pre-catalyst, from example 1, was subjected to the immobilization reaction with the activated and modified silica. Specifically, 2 grams of activated and modified silica were used, suspended in 50 ml toluene. Then, the pre-catalyst solution recently extracted in benzene, from example 1, was added. The weight percentage of added catalyst corresponded to 10% by weight of the used silica.

The pre-catalyst:silica mixture was stirred at room temperature for six hours more, then the solution was filtered under Ar atmosphere and washed several times to remove the pre-catalyst residues not chemically deposited on the silica.

When the reaction was completed, a color change in the support was seen, from white to pink or dark pink.

### Example 3

### Pre-Catalyst Activation

Supported pre-catalyst, from example 2, activation was achieved in a 100 ml Schienk, wherein the required amount of impregnated silica powder was suspended in 5 ml of toluene. Then, the corresponding amount of MAO in ml was added.

### EXAMPLES 4-18

### α-Olefins and Conjugated Dienes Polymerization

All catalysts employed in the following examples 4-18 were synthesized, made heterogeneous and activated according to the techniques described in the above Examples 1-3.

For the polymerization, a reactor provided with a heating jacket, mechanical stirring and catalyst addition burette was provided. Further, a flowmeter for the gaseous monomer consumption measurement, temperature control and an inlet for the addition of transference agents, such as hydrogen, were provided in the reactor. In these examples, the reactor worked at a stirring of 600 rpm.

### Example 4

Using the catalytic system nBuCp₂ZrHAlH₄/SiO₂/MAO (0.05 g) in hexane (200 ml) at 50° C. and 2.95 kg/cm² (42 psi) for 30 minutes, an ethylene polymerization was carried out. The silica supported pre-catalyst was previously activated with MAO outside the polymerization reactor. After acidified methanol was added, 13 g of the polymer having a molecular weight (Mw) of 3.4×10⁴, and a polydispersity (Mw/Mn) of 1.8 were obtained. The resulting polyethylene structure was highly linear (high density polyethylene) (HDPE).

### Example 5

Using the catalytic system nBuCp₂ZrHAlH₄/SiO₂/MAO (0.05 g) at 2.95 kg/cm² (42 psi), an ethylene polymerization was carried out. The polymerization was made in toluene (200 ml) at a temperature of 50° C. for 30 minutes. The silica supported pre-catalyst was previously activated with MAO outside the polymerization reactor. After adding acidified methanol, 11 g of the polymer having a molecular weight (Mw) of 7.2×10⁴, and a polydispersity (Mw/Mn) of 1.9 were obtained. The resulting polyethylene structure was highly linear (HDPE).

### Example 6

Using the catalytic system nBuCp₂ZrHAlH₄/SiO₂/MAO (0.05 g) at 2.95 kg/cm² (42 psi), iso-octane (200 ml) as solvent and a temperature of 50° C. for 30 minutes, the ethylene polymerization was carried out. The silica supported pre-catalyst was previously activated with MAO outside the polymerization reactor. After acidified methanol was added, 10.6 g of the polymer having a molecular weight (Mw) of 8.5×10⁴ and a polydispersity (Mw/Mn) of 2.1 were obtained. The resulting polyethylene structure was highly linear (HDPE).

### Example 7

Again, using the catalytic system nBuCp₂ZrHAlH₄/SiO₂/MAO (0.05 g) in hexane (200 ml) at 70° C. and 2.95 kg/cm² (42 psi) for 30 minutes, the ethylene polymerization was carried out. The silica supported pre-catalyst was previously activated with MAO outside the polymerization reactor. After acidified methanol was added, 12.3 g of the polymer having a molecular weight (Mw) of 3.6×10⁴, and a polydispersion (Mw/Mn) of 1.9 were obtained. The resulting polyethylene structure was highly linear (HDPE).

### Example 8

Using the catalytic system nBuCp₂ZrHAlH₄/SiO₂/MAO (0.05 g) in toluene (200 ml) at 70° C. and 2.95 kg/cm² (42 psi) for 30 minutes, an ethylene polymerization was carried out. The silica supported pre-catalyst was previously activated with MAO outside the polymerization reactor. After acidified methanol was added, 13.0 g of the polymer having a molecular weight (Mw) of 5.1×10⁴, and a polydispersity (Mw/Mn) of 2.1 were obtained. The resulting polyethylene structure was highly linear (HDPE).

### Example 9

Using the catalytic system nBuCp₂ZrHAlH₄/SiO₂/MAO (0.05 g) in iso-octane (200 ml) at 70° C. and 2.95 kg/cm² (42 psi) for 30 minutes, the ethylene polymerization was carried out. The silica supported pre-catalyst was previously activated with MAO outside the polymerization reactor. After acidified methanol was added, 13.0 g of the polymer having a molecular weight (Mw) of 7.6×10⁴, and a polydispersity (Mw/Mn) of 2.2 were obtained. The resulting polyethylene structure was highly linear (HDPE).

### Example 10

Using the catalytic system nBuCp₂ZrHAlH₄/SiO₂/MAO (0.05 g) in iso-octane (200 ml) at 50° C. and 2.95 kg/cm² (42 psi) for 30 minutes, the ethylene-1-hexene (6 ml) co-polymerization was carried out. The silica supported pre-catalyst was previously activated with MAO outside the polymerization reactor. After acidified methanol was added, 5 g of the polymer having a molecular weight (Mw) of 4.5×10⁴, and a polydispersity (Mw/Mn) of 2.5 were obtained. The resulting polyethylene structure was medium density linear.

### Example 11

Using the catalytic system nBuCp₂ZrHAlH₄/SiO₂/MAO (0.05 g) in iso-octane (200 ml) at 50° C. and 2.95 kg/cm² (42 psi) for 30 minutes, the ethylene-1,3-butadiene (10 ml) co-polymerization was carried out. The silica supported pre-catalyst was previously activated with MAO outside the polymerization reactor. After acidified methanol was added, 6.1 g of the polymer having a molecular weight (Mw) of 3.5×10⁴, and a polydispersity (Mw/Mn) of 2.7 were obtained. The resulting polyethylene structure was medium density linear.

### Example 12

Using the catalytic system nBuCp₂ZrHAlH₄/SiO₂/MAO (0.1 g) in hexane (2.5 I) at 60° C. and 7.03 kg/cm² (100 psi) for 3.5 hours, the ethylene polymerization was carried out. The silica supported pre-catalyst was previously activated with MAO within the polymerization reactor. The polymer was washed with methanol, yielding 362 g of the polymer having a molecular weight (Mw) of 5.7×10⁴, and a polydispersity (Mw/Mn) of 2.3. The resulting polyethylene structure was highly linear (HDPE).

### Example 13

Using the catalytic system SiMe₃Cp₂ZrHAlH₄/SiO₂/MAO (0.1 g) in hexane (2.5 I) at 60° C. and 7.03 kg/cm² (100 psi) for 3.5 hours, the ethylene polymerization was carried out. The silica supported pre-catalyst was previously activated with MAO within the polymerization reactor. The polymer was washed with methanol, yielding 150 g of the polymer having a molecular weight (Mw) of 9.8×10⁴, and a polydispersity (Mw/Mn) of 3.1. The resulting polyethylene structure was highly linear (HDPE).

### Example 14

Using the catalytic system SiMe₃Cp₂ZrHAlH₄/SiO₂/MAO (0.1 g) in hexane (2.5 I) at 60° C. and 7.03 kg/cm² (100 psi) for 3.5 hours, the ethylene-1-hexene (15 ml) co-polymerization was carried out. The silica supported pre-catalyst was previously activated with MAO within the polymerization reactor. The polymer was washed with methanol, yielding 300 g of the polymer having a molecular weight (Mw) of 6.9×10⁴, and a polydispersity (Mw/Mn) of 3.0. The resulting polyethylene structure was linear of medium density.

### Example 15

Using the catalytic system nBuCp₂ZrHAlH₄/SiO₂/MAO (0.1 g) in hexane (2.5 I) at 60° C. and 7.03 kg/cm² (100 psi) for 3.5 hours, the propylene polymerization was carried out. The silica supported pre-catalyst was previously activated with MAO within the polymerization reactor. The polymer was washed with methanol, yielding 120 g of the polymer having a molecular weight (Mw) of 2.3×10⁴, and a polydispersity (Mw/Mn) of 1.9. The resulting polyethylene structure was partially isotactic.

### Example 16

Using the catalytic system SiMe₃Cp₂ZrHAlH₄/SiO₂/MAO (0.1 g) in hexane (2.5 I) at 60° C. and 7.03 kg/cm² (100 psi) for 3.5 hours, the propylene polymerization was carried out. The silica supported pre-catalyst was previously activated with MAO within the polymerization reactor. The polymer was washed with methanol, yielding 95 g of the polymer having a molecular weight (Mw) of 3.1×10⁴, and a polydispersity (Mw/Mn) of 2.5. The resulting polyethylene structure was partially isotactic.

### Example 17

Using the catalytic system SiMe₃Cp₂ZrHAlH₄/SiO₂/MAO (0.1 g) in hexane (2.5 I) at 60° C. for 3.5 hours, the ethylene 7.03 kg/cm² (100 psi)-propylene 0.70 kg/cm² (10 psi) co-polymerization was carried out. The silica supported pre-catalyst was previously activated with MAO within the polymerization reactor. The polymer was washed with methanol, yielding 315 g of the polymer having a molecular weight (Mw) of 3.0×10⁴, and a polydispersion (Mw/Mn) of 3.1. The resulting polyethylene structure was linear of medium density.

### Example 18

Using the catalytic system nBuCp₂ZrHAlH₄/SiO₂/MAO (0.1 g) in hexane (2.5 I) at 60° C. and 7.03 kg/cm² (100 psi) for 3.5 hours, the ethylene-propylene co-polymerization was carried out. The silica supported pre-catalyst was previously activated with MAO within the polymerization reactor. The polymer was washed with methanol, yielding 315 g of the polymer having a molecular weight (Mw) of 2.3×10⁴, and a polydispersion (Mw/Mn) of 3.1. The resulting polyethylene structure was linear of medium density.

Results of Examples 4-18 are summarized in table 2.

TABLE 2
Summary of results for Examples 4-18

| | | | | | | | Mol. | Poli- |
|---|---|---|---|---|---|---|---|---|
| | | P | Catalytic | | T | Activation | Weight | dispersion |
| Ex. | Monomer | Kg/cm² | System | Solvent | ° C. | DR/FR | Mw | Mw/Mn |
| 4 | Ethylene | 2.95 | nBuCp₂ZrHAlH₄/SiO₂/MAO | Hexane | 50 | FR | 3.4 × 10⁴ | 1.8 |
| 5 | Ethylene | 2.95 | nBuCp₂ZrHAlH₄/SiO₂/MAO | Toluene | 50 | FR | 7.2 × 10⁴ | 1.9 |
| 6 | Ethylene | 2.95 | nBuCp₂ZrHAlH₄/SiO₂/MAO | Iso- | 50 | FR | 8.5 × 10⁴ | 2.1 |
| | | | | octane | | | | |
| 7 | Ethylene | 2.95 | nBuCp₂ZrHAlH₄/SiO₂/MAO | Hexane | 70 | FR | 3.6 × 10⁴ | 1.9 |
| 8 | Ethylene | 2.95 | nBuCp₂ZrHAlH₄/SiO₂/MAO | Toluene | 70 | FR | 5.1 × 10⁴ | 2.1 |
| 9 | Ethylene | 2.95 | nBuCp₂ZrHAlH₄/SiO₂/MAO | Iso- | 70 | FR | 7.6 × 10⁴ | 2.2 |
| | | | | octane | | | | |
| 10 | Ethylene/ | 2.95 | nBuCp₂ZrHAlH₄/SiO₂/MAO | Iso- | 50 | FR | 4.5 × 10⁴ | 2.5 |
| | 1-Hexene | | | octane | | | | |
| 11 | Ethylene/ | 2.95 | nBuCp₂ZrHAlH₄/SiO₂/MAO | Iso- | 50 | FR | 3.5 × 10⁴ | 2.7 |
| | 1,3- | | | octane | | | | |
| | Butadiene | | | | | | | |
| 12 | Ethylene | 7.03 | nBuCp₂ZrHAlH₄/SiO₂/MAO | Hexane | 60 | DR | 5.7 × 10⁴ | 2.3 |
| 13 | Ethylene | 7.03 | SiMe₃Cp₂ZrHAlH₄/SiO₂/MAO | Hexane | 60 | DR | 9.8 × 10⁴ | 3.1 |
| 14 | Ethylene/ | 7.03 | SiMe₃Cp₂ZrHAlH₄/SiO₂/MAO | Hexane | 60 | DR | 6.9 × 10⁴ | 3.0 |
| | 1-Hexene | | | | | | | |
| 15 | Propylene | 7.03 | nBuCp₂ZrHAlH₄/SiO₂/MAO | Hexane | 60 | DR | 2.3 × 10⁴ | 1.9 |
| 16 | Propylene | 7.03 | SiMe₃Cp₂ZrHAlH₄/SiO₂/MAO | Hexane | 60 | DR | 3.1 × 10⁴ | 2.5 |
| 17 | Ethylene/ | 7.03 | SiMe₃Cp₂ZrHAlH₄/SiO₂/MAO | Hexane | 60 | DR | 3.0 × 10⁴ | 3.1 |
| | Propylene | | | | | | | |
| 18 | Ethylene/ | 7.03 | nBuCp₂ZrHAlH₄/SiO₂/MAO | Hexane | 60 | DR | 2.3 × 10⁴ | 3.1 |
| | Propylene | | | | | | | |

### Example 19

Pre-Catalyst Immobilization (Heterogeneousness) in Ethyl Ether

In order to optimize heterogeneousness steps for the hydride-alumohydride pre-catalyst, the support reaction was performed in ethyl ether at room temperature using fuming silica or PQ silica having a surface area of 416 m²/g, pore volume of 3.23 ml/g and average pore diameter of 311 Å or silica gel having a surface area of 500 m²/g, pore volume of 0.75 cc/g and mesh of 60 Å, which were activated as described in example 2. A gram of the corresponding activated silica was contacted with the zirconocene hydride-alumohydride solution (approximately 50 ml) obtained from the synthesis reaction in ethyl ether as described in example 1. The pre-catalyst:silica mixture was stirred at room temperature for six hours, then the silica was filtered and washed several times with ethyl ether to remove the pre-catalyst residues not chemically deposited, and the powder was dried under reduced pressure, vacuum (10⁻³ mmHg) for four hours. When the reaction was completed, a color change from white to pale yellow in the support was seen.

Ethylene polymerization reactions with each supported pre-catalysts in the different types of silica using ethyl ether as solvent during the heterogeneousness, showed very low or null activities, therefore, the use of ethyl ether during heterogeneousness is not suitable for metallocene hydride-alumohydrides, as determined, since the ether present in the media can be coordinated to the active centers, impeding the monomers polymerization.

### Example 20

### Solution Polymerization with Unsupported Catalyst

Using the catalytic system nBuCp₂ZrHAlH₄/SiO₂/MAO (6×10⁻⁷ mol) in iso-octane (200 ml) at 50° C. and 2.95 kg/cm² (42 psi) for 30 minutes, the ethylene homogeneous phase polymerization (unsupported catalyst) was carried out. The pre-catalyst was previously activated with MAO outside the polymerization reactor. After acidified methanol was added, 3.3 g of the polymer having a molecular weight (Mw) of 5.1×10⁴ and a polydispersity (Mw/Mn) of 3.6 were obtained. The resulting polyethylene structure was highly linear (high density polyethylene) (HDPE). If these results are compared to those in example 6, wherein similar polymerization conditions were used, a lower yielding in the polymer weight as obtained can be seen (Ex. 20, 3.36; Ex. 6, 10.6 g).

### Example 21

### Solution Polymerization with Unsupported Catalyst

Using the catalytic system nBuCp₂ZrHAlH₄/SiO₂/MAO (6×10⁻⁷ mol) in iso-octane (200 ml) at 70° C. and 2.95 kg/cm² (42 psi) for 30 minutes, the ethylene homogeneous phase polymerization (unsupported catalyst) was carried out. The pre-catalyst was previously activated with MAO outside the polymerization reactor. After acidified methanol was added, 2.3 g of the polymer having a molecular weight (Mw) of 9.1×10⁴, and a polydispersity (Mw/Mn) of 2.3 were obtained. The resulting polyethylene structure was highly linear (high density polyethylene) (HDPE). If these results are compared to those in example 9, wherein similar polymerization conditions were used, a lower yielding in the polymer weight as obtained can be seen (Ex. 21, 2.3 g; Ex. 6, 13.0 g).

According to what has been described and illustrated in the appended drawing, it may be noticed that the catalyst for heterogeneous phase olefins and conjugated dienes polymerization basically shows a higher stability, easy of handling, higher catalytic activity than the analogous system in homogenous phase. Polymers obtained in suspension with the supported hydride-alumohydrides show higher mass density, and better molecular weight control, in the sense of application. Further, supported metallocene hydride-alumohydrides show a much higher catalytic activity in co-polymerization reactions with different co-monomers compared to the same systems but in homogeneous phase, i.e., different grade polyethylenes may be obtained, which can not be possible with the same system in homogenous phase. Due to this, it will be apparent to those skilled in this art, that the above described embodiments are only illustrative and not limitative in any way of the invention, since there are many modifications which can be made, for example, the transition metal, the monomer to be polymerized, reaction conditions, etc., such modifications without altering the scope of the invention.

Although specific embodiments of the invention have been described and illustrated, it must be noted that it is possible to make many modifications to the invention. Therefore, the present invention may not be considered restricted except for what the prior art demands and the appended claims.

1. A catalyst for the heterogeneous phase olefins and conjugated dienes polymerization, comprising:
a) a pre-catalyst consisting of a mixture of metallocene hydride-alumohydride compounds represented by the following formulae:
(CpRₓ)T_{y}(CpR′_{z})MHAlH₄ (I)
[(CpRₓ)T_{y}(CpR′_{z})MHAlH₄]₂ (II)
[(CpRₓ)T_{y}(CpR′_{z})MH]₂AlH₅ (III)
wherein, M is a transition metal selected from the group consisting of Ti, Zr and Hf in its oxidation state of +4;
Cp is either i) a cyclopentadienyl ring, unsubstituted or substituted with R or R′; or ii) a cyclopentadienyl ring wherein two neighboring rings are attached forming from 4 to 20 carbon atoms cycles such that saturated or unsaturated polycyclic cyclopentadienyl links are formed;
R and R′ are cyclopentadientyl ring substituents which are selected from the group consisting of hydrocarbon radicals wherein one or more hydrogen or carbon atoms are replaced heteroatoms containing radicals selected from the 13 to 17 groups of the periodic table, and heteroatoms substituted with hydrogen or substituted with hydrocarbon radicals; R and R′ are the same or different;
“x” and “z” are integers ranging from 0 to 5, and denoting the substitution level for the cyclopentadienyl rings.
T is a straight or branched, cyclic or acyclic, bridged covalent group bonding the cyclopentadienyl rings (Cp); and,
“y” is an integer which may be 0 or 1;
b) a modified silica to immobilize the pre-catalyst; and,
c) a co-catalyst selected from methylaluminoxane (MAO), modified methylaluminoxane (MMAO) and a boride compound of the general formula B(C₆H_{5-K}Fₖ)₃ or PB(C₆H_{5-K}Fₖ)₄; wherein K is an integer ranging from 0 to 5; and, P is a cation capable of taking off an hydride atom forming a neutral species not showing a Lewis' basic functionality.

2. A catalyst for the heterogeneous phase olefins and conjugated dienes polymerization, according to claim 1, wherein when “y” is 1, T is selected from the group consisting of hydrocarbon radicals wherein one or more hydrogen or carbon atoms are replaced by heteroatoms containing radicals selected from the 13 to 17 groups of the periodic table, and hydrogen or hydrocarbon radicals substituted heteroatoms.

3. A catalyst for the heterogeneous phase olefins and conjugated dienes polymerization, according to claim 2, wherein the heteroatoms are selected from the 14 group of the periodic table.

4. A catalyst for the heterogeneous phase olefins and conjugated dienes polymerization, according to claim 2, wherein T is selected from the group consisting of methylidene, iso-propylidene, diphenylmethylidene, ethylidene, cyclohexylidene, 4-piperidinylidene, 4-tetrahydropiranylidene, dimethylsilydene, diethylsilylidene, diphenylsilylidene, tetramethylsilylidene, tetramethyldisiloxane, borilidene, methylborilidene, phenylborilidene, methylimine, n-butylimine, oxo and sulphur.

5. A catalyst for the heterogeneous phase olefins and conjugated dienes polymerization, according to claim 1, wherein R and R′ are hydrocarbon radicals wherein one or more atoms thereof are replaced with heteroatoms containing radicals from the 14 group of the periodic table.

6. A catalyst for the heterogeneous phase olefins and conjugated dienes polymerization, according to claim 1, wherein the cyclopentadienyl rings (CpRₓ) and (CpR′_{z}) are one or both selected from the group consisting of cyclopentadienyl, methylcyclopentadienyl, di methylcyclopentadienyl, tetramethylcyclopentadienyl, pentamethylcyclopentadienyl, tert-butylcyclopentadienyl, 1-tert-butyl-3-methylcyclopentadienyl, trimethylsilylcyclopentadienyl, 1-trimethylsilyl-3-methylcyclopentadienyl, di-tert-butylcyclopentadienyl, dimethylborilcyclopentadienyl, indenyl, tetrahydroindenyl, fluorenyl, octahydrofluorenyl, tert-butylindenyl, trimethylsilylindenyl, tert-butyltetrahydroindenyl, trimethylsilyltetrahydroindenyl and 2,7-dimesithyloctahydrofluorenyl.

7. A catalyst for the heterogeneous phase olefins and conjugated dienes polymerization, according to claim 1, wherein the silica is modified by a heat treatment and an activator component selected from the group consisting of trialkylaluminium (AlR3), MAO or MMAO.

8. A catalyst for the heterogeneous phase olefins and conjugated dienes polymerization, according to claim 7, wherein the silica is fuming silica or PQ silica.

9. A catalyst for the heterogeneous phase olefins and conjugated dienes polymerization, according to claim 1, wherein the co-catalyst is B(C₆F₅)₃ or CPh₃B(C₆F₅)₄.

10. A catalyst for the heterogeneous phase olefins and conjugated dienes polymerization, according to claim 1, wherein the co-catalyst is MAO or MMAO.

11. A catalyst for the heterogeneous phase olefins and conjugated dienes polymerization, according to claim 1, wherein in the catalyst, the molar ratio of MAO or MMAO with respect to the molar total of the metallocene hydride-alumohydride compounds of the formulas I, II and III, is from 10:1 to 20, 000:1.

12. A process to obtain a catalyst as defined in claim 1, wherein the process comprises the steps of:
a) preparing a pre-catalyst solution consisting of a mixture of the metallocene and aluminium hydride compounds of the formulas (I), (II) or (III) as defined in claim 1;
b) heat treating the silica;
c) modifying the silica by an activator selected from the group consisting of a trialkylaluminium (AlR3), MAO or MMAO;
d) reacting the pre-catalyst solution with the modified silica obtained in step (c), such that when the reaction is completed, the silica remains impregnated with the pre-catalyst;
e) drying the pre-catalyst impregnated silica; and,
f) activating the pre-catalyst with a co-catalyst selected from the group consisting of methylaluminoxane (MAO), modified methylaluminoxane (MMAO) or a boride compound of the formula B(C₆H_{5-K}Fₖ)₃ or PB(C₆H_{5-K}Fₖ)₄; wherein K is an integer ranging from 0 to 5; and, P is a cation capable of taking off an hydride atom forming a species not showing a Lewis' basic functionality.

13. A process to prepare a catalyst, according to claim 12, wherein in step (a), the pre-catalyst is dissolved in an organic solvent selected from the group consisting of benzene, toluene, hexane and isomers thereof, methylene chloride, chloroform and trichlorobenzene.

14. A process to prepare a catalyst for the olefins and conjugated dienes polymerization, according to claim 12, wherein in step (b), the silica is treated at a temperature between from 400° C. to 800° C. in presence of an oxygen stream.

15. A process to prepare a catalyst for the olefins and conjugated dienes polymerization, according to claim 12, wherein in step (b), the treated silica is fuming silica or PQ silica.

16. A process to prepare a catalyst for the olefins and conjugated dienes polymerization, according to claim 12, wherein in step (c), from 10 to 45% by weight ratio of the activator agent with respect to the silica is used.

17. A process to prepare a catalyst for the olefins and conjugated dienes polymerization, according to claim 12, wherein in step (c), the trialkylaliminium compound is selected from the group consisting of Et₃Al, Me₃Al and iBu₃Al.

18. A process to prepare a catalyst for the olefins and conjugated dienes polymerization, according to claim 12, wherein in step (d), the modified silica is suspended in a solvent selected from the group consisting on toluene, hexane, benzene, methylene chloride and chloroform.

19. A process to prepare a catalyst for the olefins and conjugated dienes polymerization, according to claim 18, wherein in steps (d) and (e), the method comprises the additional step of washing the impregnated silica using the same solvent whereby the silica was suspended in the step (d).

20. A process to prepare a catalyst for the olefins and conjugated dienes polymerization, according to claim 12, wherein in reaction step (d), a pre-catalyst/silica (Al:Si) from 1:10 to 1:100 molar ratio, is used.

21. A process to prepare a catalyst for the olefins and conjugated dienes polymerization, according to claim 12, wherein the reaction step (c) is performed under an inert gas atmosphere.

22. A process to prepare a catalyst for the olefins and conjugated dienes polymerization, according to claim 12, wherein the drying step (e) is carried out evaporating under vacuum the reaction mixture so the impregnated inorganic support precipitates.

23. A process to prepare a catalyst for the olefins and conjugated dienes polymerization, according to claim 12, wherein the temperature in the activation step (f) is from −50 to 30° C.

24. A process to prepare a catalyst for the olefins and conjugated dienes polymerization, according to claim 12, wherein in the activation step (f), the co-catalyst is MAO, B(C₆F₅), or CPh₃(B(C₆F₅)₄.

25. A process to prepare a catalyst for the olefins and conjugated dienes polymerization, according to claim 24, wherein in the activation step (f), between 1 and 20000 MAO equivalents by transition metal mol contained in the impregnated support are added.

26. A process for the heterogeneous phase olefins and conjugated dienes polymerization, wherein the polymerization process comprises the steps of:
a) reacting under polymerization conditions at least one olefin and/or at least one conjugated diene in contact with a catalyst as defined in claim 1; and,
b) recovering the polymer thus formed.

27. A process for the heterogeneous phase olefins and conjugated dienes polymerization, according to claim 26, wherein the polymerization reaction is carried out in gaseous phase or suspension.

28. A process for the heterogeneous phase olefins and conjugated dienes polymerization, according to claim 27, wherein the suspension polymerization comprises the steps of: i) charging a reactor with a suitable solvent for the reaction; ii) optionally, adding a purifying agent; iii) saturating the reactor with the corresponding monomer at the polymerization pressure or adding liquid monomer; iv) adding the suspension prepared catalyst; and, v) allow the polymerization for sufficient time.

29. A process for the heterogeneous phase olefins and conjugated dienes polymerization, according to claim 28, wherein in step (i) the co-catalyst is added to the reactor together with said solvent, and in step (iv), the pre-catalyst is added in its deactivated state to be activated by the co-catalyst inside the reactor.

30. A process for the heterogeneous phase olefins and conjugated dienes polymerization, according to claim 27, wherein the gaseous phase polymerization comprises the steps of: i) charging a reactor with a suitable solvent for the reaction and adding the catalyst; ii) optionally ii) optionally, adding a purifying agent; iii) saturating the reactor with the corresponding monomer at the polymerization pressure or adding liquid monomer; and, v) allow the polymerization for sufficient time.

31. A process for the heterogeneous phase olefins and conjugated dienes polymerization, according to claim 26, wherein the polymerization is carried out in a fluidized bed reactor.

32. A process for the heterogeneous phase olefins and conjugated dienes polymerization, according to claim 26, wherein said olefin to be polymerized has the general formula
CH₂═CH—CHXY (IV)
wherein “x” and “y” are independently and hydrogen atom; a straight or branched, cyclic, saturated or unsaturated hydrocarbon radical; a straight or branched, cyclic, saturated or unsaturated hydrocarbon radical wherein one or more hydrogen atoms are replaced by heteroatoms containing radicals selected from the 13 to 17 groups of the periodic table; heteroatoms selected from the 13 to 17 groups of the periodic table substituted with oxygen or hydrocarbon radicals.

33. A process for the heterogeneous phase olefins and conjugated dienes polymerization, according to claim 26, wherein, when olefins are polymerized, the main polymers and co-polymers resulting chains have a fragment content formed by the 1,3 insertion from 0.1 to 95%.

34. A process for the heterogeneous phase olefins and conjugated dienes polymerization, according to claim 26, wherein, when olefins are polymerized, the resulting polymers and co-polymers tacticity is from 40% to 80%.

35. A process for the heterogeneous phase olefins and conjugated dienes polymerization, according to claim 26, wherein the conjugated dienes are selected from the group consisting of butadiene, isoprene, cyclopentadiene, unsubstituted or substituted with alkyl, haloalkyl or alkylsilyl groups.

36. A process for the heterogeneous phase olefins and conjugated dienes polymerization, according to claim 35, wherein said conjugated diene is a cyclopentadiene unsubstituted or substituted with alkyl, haloalkyl or alkylsylil groups.

37. A process for the heterogeneous phase olefins and conjugated dienes polymerization, according to claim 36, wherein the polymerization of substituted and unsubstituted cyclopentadienes lead to polycyclopentadienes having repetitive fragments of the formula VII 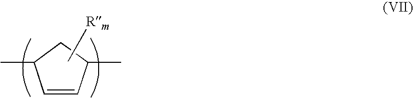
wherein the fragments of the formula VII are at least 95% the resulting polymer, where “m” is an integer ranging from 0 to 3 and R″ is a hydrocarbon radical or trialkylsilyl.

38. A process for the heterogeneous phase olefins and conjugated dienes polymerization, according to claim 26, wherein the polymerization of conjugated dienes lead to main insertion 1-4 cis fragments from 40% to 95%.

39. A process for the heterogeneous phase olefins and conjugated dienes polymerization, according to claim 26, wherein the polymers thus obtained have a molecular weight up to 1.5×10⁶.

40. A process for the heterogeneous phase olefins and conjugated dienes polymerization, according to claim 26, wherein the resulting polymers have a polidispersity between 2 and 4.
